(19) United States
(12) Patent Application Publication
(10) Pub. No.: US 2013/0205499 A1
(43) Pub. Date: Aug. 15, 2013

(54) SUPPORT BRACKET FOR MEDICAL EQUIPMENT AND USES THEREOF

(71) Applicant: University of Rochester, (US)

(72) Inventor: John T. VAY, Rochester, NY (US)

(73) Assignee: UNIVERSITY OF ROCHESTER, Rochester, NY (US)

(21) Appl. No.: 13/763,184

(22) Filed: Feb. 8, 2013

Related U.S. Application Data
(60) Provisional application No. 61/597,083, filed on Feb. 9, 2012.

(51) Int. Cl. A61G 7/05

(52) U.S. Cl. CPC A61G 7/0503
USPC 5/503.1; 211/13.1

(57) ABSTRACT

The present invention relates to a medical support device and uses thereof. The medical support device includes a stem defining a longitudinal axis, the stem having an upper end and a lower end, the lower end adapted for securing the device to a receptacle. The medical support device also includes an elongate member permanently secured to the stem and extending outwardly from said stem at an angle to the longitudinal axis, the elongate member having an end proximate to said stem and an end distal to said stem, and a plurality of medical equipment support elements fixed to a lower surface of the elongate member between the distal end and a point intermediate the proximal and distal ends.

This application claims the benefit of U.S. Provisional Patent Application Ser. No. 61/597,083, filed Feb. 9, 2012, which is hereby incorporated by reference in its entirety.

### FIELD OF THE INVENTION

The present invention relates to a support bracket for use in medical applications.

### BACKGROUND OF THE INVENTION

Patients in hospital beds, nursing home beds, or other treatment beds often require medical apparatus for, e.g., introducing or removing fluids from the body or physically supporting portions of the body. When providing care to premature infants, normal infants, or any other patient, the precise application of feeding material or other activity ideally requires that the syringe, tubing, conduits, tethers, or other medical apparatus operate undisturbed and unimpeded. Further, because medical apparatus are of different sizes and employ different capacities, the physical orientation and weight of the medical apparatus employed varies. Currently available support devices and methods are not flexible enough to satisfactorily address this variation in size, weight, and orientation to the patient's body while permitting easy access to the patient.

For example, physicians may be presented with a patient that has exposed internal body parts protruding outside the body. One example situation where this occurs is with gastrochisis. Gastroschisis (also called paraomphalocele, laparoschisis, abdominoschisis, or abdominal hernia) is a type of inherited congenital abdominal wall defect in which the intestines and sometimes other organs develop outside the fetal abdomen through an opening in the abdominal wall near the site of the umbilicus. In gastroschisis, the abdominal wall does not close properly and the stomach, small bowel, and/or large intestine may have come through the small opening near the umbilical cord. Within the womb, these internal body parts are floating free within the amniotic fluid and may not typically present any harm to the baby; however, once born, the baby will require immediate attention.

Surgical pouches, such as sterile plastic or silicone bags, often referred to as “silo” bags, are placed around the exposed internal body parts and used to contain the exposed internal body parts so that they may be shielded from trauma, infection, and dehydration until the body parts are put back within the body. Often the exposed internal body parts may be swollen and inflamed and require time before the swelling and inflammation subside to permit the internal body parts to be safely put back within the body. During this time, the surgical pouch may be suspended above the abdomen of the patient. Devices currently available to support such medical equipment offer little flexibility with respect to placement relative to the body and movement for easy access to the patient without disrupting or causing harm to the patient. Thus, there is presently a need for a support bracket suitable to support, inter alia, an infant gastroschisis silo.

The present invention is directed to overcoming these and other deficiencies in the art.

### SUMMARY OF THE INVENTION

A first aspect of the present invention relates to a medical support device. The medical support device includes a stem defining a longitudinal axis, the stem having an upper end and a lower end, the lower end adapted for securing the device to a receptacle. The medical support device also includes an elongate member permanently secured to the stem and extending outwardly from said stem at an angle to the longitudinal axis, the elongate member having an end proximate to said stem and an end distal to said stem, and a plurality of medical equipment support elements fixed to a lower surface of the elongate member between the distal end and a point intermediate the proximal and distal ends.

A second aspect of the present invention includes, in combination, an infant bed comprising a receptacle and a medical support device according to the present invention. According to this aspect, the medical support device according to the present invention has the lower end of the stem secured in the receptacle.

A third aspect of the present invention relates to a method for supporting an infant gastroschisis silo. The method includes providing a medical support device according to the present invention installed on an infant bed, where the lower end of the stem is secured in a bed receptacle whereby the distal end of said elongate member is positioned substantially above an infant subject; and connecting a tether between a gastroschisis silo on the infant subject and one of the plurality of medical equipment support elements to support the silo.

The present invention provides significant advantages over other available support mechanisms for medical equipment in association with a patient's body. The versatility of the device of the present invention to accommodate a diverse range of medical equipment offers a particular advantage over currently available devices. The present invention also has the unique quality of permitting easy access to the patient without disrupting the association of the medical apparatus with the patient's body or harming the patient. This is a significant advantage, particularly with respect to supporting, for example, an infant gastroschisis silo.

### BRIEF DESCRIPTION OF THE DRAWINGS

FIG. 1 is a top right perspective view of a support bracket.

FIG. 2A is a left side view of the support bracket shown in FIG. 1. FIG. 2B is an exploded view of the indicated portion of FIG. 2A. FIG. 2C illustrates an alternative embodiment of medical equipment support elements shown in FIG. 2B.

FIG. 3 is a top plan view of the support bracket shown in FIG. 1.

FIG. 4 is a bottom plan view of the support bracket shown in FIG. 1.

FIG. 5 is a rear end view of the support bracket shown in FIG. 1.

FIG. 6 is a front end view of the support bracket shown in FIG. 1.

### DETAILED DESCRIPTION OF THE INVENTION

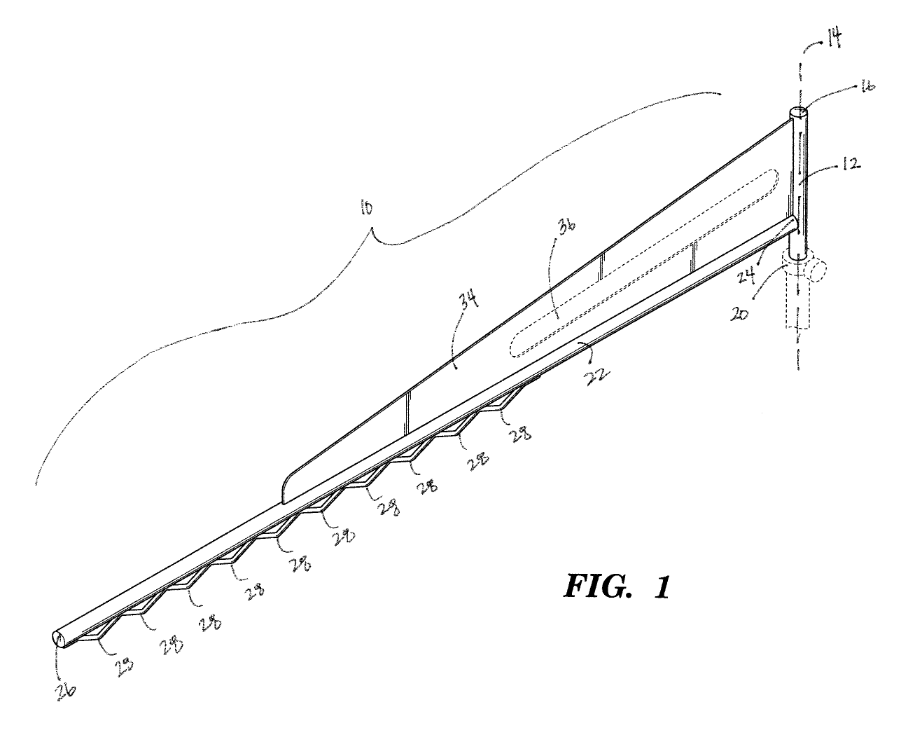

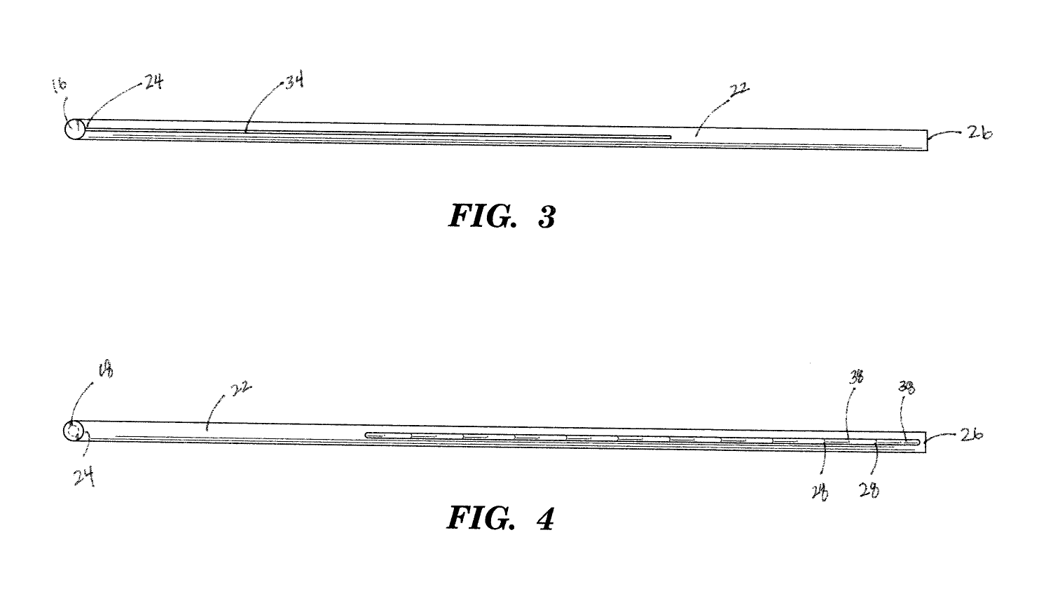

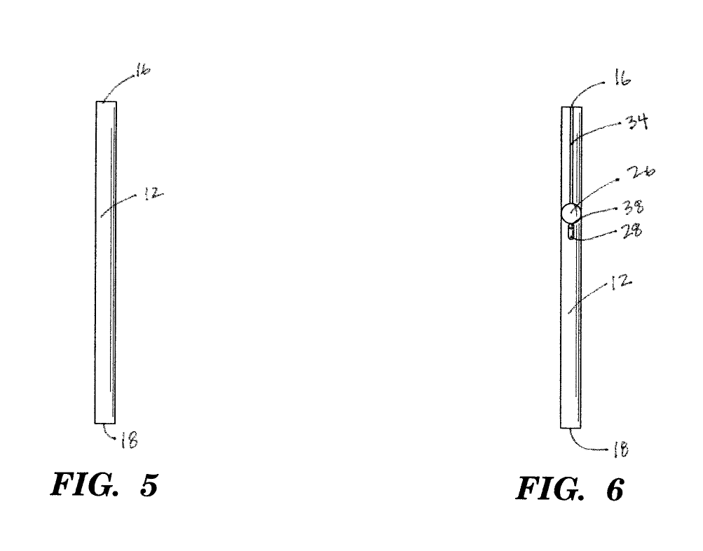

With reference to FIGS. 1-6, a first aspect of the present invention relates to a medical support device 10. The medical support device 10 includes a stem 12, an elongate member 22, and a plurality of medical equipment support elements 28.

The stem 12 defines a longitudinal axis 14, and has an upper end 16 and a lower end 18. The lower end 20 is adapted for securing device 10 to a receptacle 20. The elongate member 22 is permanently secured to stem 12 and extends outwardly from stem 12 at an angle to longitudinal axis 14. The elongate member 22 has one end 24 proximate to stem 12 and another end 26 distal to stem 12. The plurality of medical equipment support elements 28 are fixed to a lower surface of elongate member 22 between the distal end 26 and a point intermediate the proximal 24 and distal 26 ends.

In the embodiment illustrated in FIG. 1, the receptacle 20 represents a receptacle on an infant bed, such as a pediatric warmer of the type available from GE Healthcare. The receptacle 20 is adapted to receive the lower end of the stem 12 during use of the device 10.

Stem 12 and elongate member 22 may each have any shape suitable to a person of skill in the art. For example, stem 12 and elongate member 22 may have a substantially circular, cubed, or triangular cross-sectional profile, although a circular cross-sectional profile is preferred. Stem 12 and elongate member 22 may also be hollow (e.g., tubular) or composed of a solid material. In one embodiment according to the present invention stem 12 is substantially cylindrical and composed of a solid material, and elongate member 22 is a substantially cylindrical tube.

As noted above, the elongate member 22 is permanently secured to stem 12. In one embodiment, the elongate member 22 is secured to stem 12 at a location that is above the midpoint between its upper end 16 and lower end 18. In one embodiment, elongate member 22 is secured to stem 12 at a point that is on upper half 32 of stem 12. As noted above, in one embodiment according to the present invention, elongate member 22 is secured to stem 12 and extends outwardly from stem 12 at an angle to longitudinal axis 14. In one embodiment, the elongate member extends outwardly from stem 12 at an angle substantially normal to longitudinal axis 14. The angle may be about 85° to about 95°, preferably about 87.5° to about 92.5°, about 89.5° to about 90.5°, or exactly 90°.

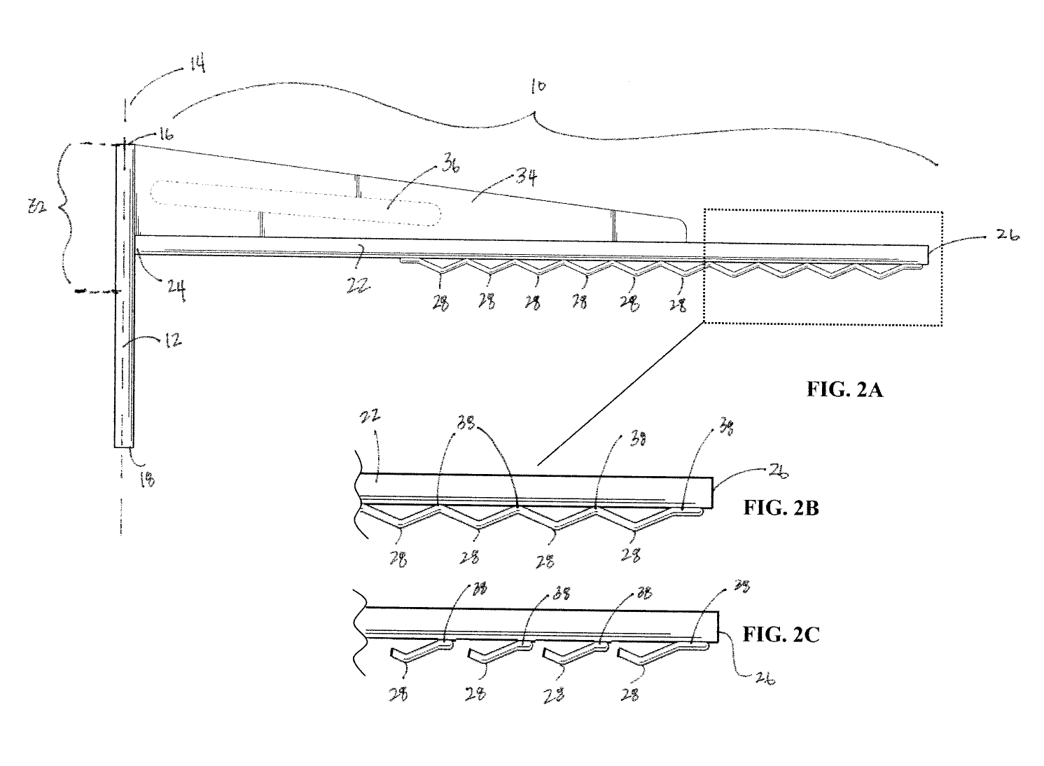

The medical support elements 28 may be of any shape or structure suitable to hold or support a tether. In particular, in one embodiment, the plurality of medical support elements 28 each have a closed loop structure (FIG. 2B). In another embodiment, medical support elements 28 each have an open loop structure (FIG. 2C). In yet another embodiment, the plurality of medical support elements 28 are a combination of medical support elements 28 that have an open loop structure and medical support elements 28 that have a closed loop structure. It should also be understood that medical support device 10 according to the present invention may include a single medical support element 28, if desired.

The medical support elements 28, as shown, preferably have an arcuate configuration with a trough that allows for tethering medical equipment to the elongate member 22.

Medical support elements 28 are fixed to elongate member 22 using any suitable permanent connection. For example, the several points of contact 38 between the elongate member 22 and the medical support elements 28 represent a plurality of welded joints. In one embodiment, medical support elements 28 are fixed to the lower surface of elongate member 22. Regardless of the number of medical support elements 28, they can be secured to the elongate member 22 individually (FIG. 2C) or collectively (FIG. 2B). In the latter embodiment, the medical support elements 28 are formed in a single piece of material which is then secured to the lower surface of the elongate member 22.

Medical support elements 28 are preferably fixed to elongate member 22 between distal end 26 and a point intermediate proximal 24 and distal 26 ends. In one embodiment the point intermediate proximal 24 and distal 26 ends is between the midpoint and the proximate end 24 of elongate member 22. In another embodiment the point intermediate proximal 24 and distal 26 ends is between the midpoint and distal end 26 of elongate member 22. In one embodiment medical support elements 28 are fixed to greater than about 50%, greater than about 60%, greater than about 70%, greater than about 80%, or greater than about 90% of the length of elongate member 22. In another embodiment, medical support elements 28 are fixed to less than about 50%, less than about 40%, less than about 30%, less than about 20%, or less than about 10% of the length of elongate member 22. The larger the coverage of the medical support element 28 along the length of the elongate member 22, then the greater flexibility of using the device to support medical equipment.

In one embodiment, medical support device 10 also includes support 34 secured to both the stem 12 and the elongate member 22. In one embodiment, support 34 is secured at or proximate to upper end 16 of stem 12 and to at least 50% of the length of the elongate member 22. In certain embodiments the support 34 extends beyond the midpoint of the elongate member. Support 34 may take any suitable shape and may be solid or hollow (e.g., tube). In one embodiment, support 34 is in the form of a stiffener plate. In one embodiment, the stiffener plate may optionally include an aperture 36. Aperture 36 helps to reduce the overall weight of the device without compromising function of support 34.

In one embodiment of medical support device 10, the lower end 18 of stem 12 includes a receptacle attachment assembly. In one embodiment, the receptacle attachment assembly includes a fastener and a washer having a diameter that is greater that that of the receptacle. In this embodiment, lower end 18 of stem 12 is adapted to receive the fastener to retain the washer against lower end 18 of stem 12. In one embodiment, the fastener is threaded (e.g., a machine screw) and lower end 18 of stem 12 is threaded to receive the threaded fastener. The washer, which is coupled to the fastener, is thereby held or retained against lower end 18 of stem 12. In use, lower end 18 of stem 12 is received by, or inserted into, e.g., receptacle 20. The fastener and washer are then secured to the lower end 18 of stem 12. Since the diameter of the washer is greater than that of the receptacle, the washer prevents removal of the lower end 18 of stem 12 from the receptacle.

The receptacle attachment assembly permits medical support device 10 to be rotated within the receptacle 20. Rotation within the receptacle 20 permits elongate member 22 to rotate to the appropriate or optimal position relative to the patient's body and/or to permit easy access to the patient for medical attention. The receptacle attachment assembly may also include a lock to prevent rotation.

The components of medical support device 10 may also be formed of any suitable material known to those of skill in the art. For instance, the components may each be formed of materials independently selected from the group consisting of iron, stainless steel, steel, aluminum, bronze, alloys, titanium, plastics, or combinations thereof. In one embodiment, the entire device is formed of stainless steel components that are welded together.

A receptacle according to the present invention includes any receptacle suitable to receive the lower end of the stem according to the present invention. The receptacle 20 may be of any suitable shape to receive the lower end 18 of the stem 12 (e.g., hollow tube) and formed of any suitable material, as described above. In one embodiment, the receptacle 20 may be part of a stand-alone base (e.g., intravenous pole assembly) or mounted to a separate structure (e.g., medical bed such as an infant warming bed).

Another aspect of the present invention includes, in combination, an infant bed comprising a receptacle and a medical support device 10 according to the present invention. In this embodiment, the lower end 18 of stem 12 is secured in the receptacle. The infant bed may be any infant bed requiring such a medical support device 10. For example, the infant bed may include an infant incubator, an infant warming bed, or any hospital bed suitable for use with an infant.

The medical support device 10 is intended to be used for supporting any medical equipment that is being used to treat an infant patient. In one embodiment, the medical equipment is a gastroschisis silo. Upon placement of lower end of a silo onto an infant, the upper end of the silo can be tethered to one of the plurality of medical equipment support elements 28 to support the silo. Because of the construction of the medical device, the medical device does not interfere with warming operations. Further, should access to the infant be necessary, i.e., for taking x-rays or other procedures, then the entire device can be rotated within the receptacle so that the elongate member does not interfere with those procedures. Afterwards, the elongate member can be moved back into place.

Accordingly, another aspect of the present invention relates to a method for supporting an infant gastroschisis silo. The method includes providing a medical support device according to the present invention installed on an infant bed, where the lower end of the stem is secured in a bed receptacle whereby the distal end of said elongate member is positioned substantially above an infant subject; and connecting a tether between a gastroschisis silo on the infant subject and one of the plurality of medical equipment support elements to support the silo.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A medical support device comprising:
a stem defining a longitudinal axis, said stem having an upper end and a lower end, the lower end adapted for securing the device to a receptacle;
an elongate member permanently secured to said stem and extending outwardly from said stem at an angle to the longitudinal axis, the elongate member having an end proximate to said stem and an end distal to said stem; and
a plurality of medical equipment support elements fixed to a lower surface of the elongate member between the distal end and a point intermediate the proximal and distal ends.

2. The medical support device according to claim 1, wherein said stem is substantially cylindrical and composed of a solid material.

3. The medical support device according to claim 1, wherein said elongate member is a substantially cylindrical tube.

4. The medical support device according to claim 1, wherein said stem, said elongate member, said plurality of medical equipment support elements, and said support are formed of a metal.

5. The medical support device according to claim 1, wherein the plurality of medical equipment support elements each have a closed loop structure.

6. The medical support device according to claim 1, wherein the plurality of medical equipment support elements each have an open loop structure.

7. The medical support device according to claim 1, wherein the point intermediate the proximal and distal ends is between the midpoint and the proximate end of said elongate member.

8. The medical support device according to claim 1 further comprising:
a support secured at or proximate to the upper end of said stem and to said elongate member.

9. The medical support device according to claim 8, wherein said support is a stiffener plate.

10. The medical support device according to claim 9, wherein the stiffener plate includes an aperture.

11. The medical support device according to claim 1, wherein the lower end of said stem further comprises a receptacle attachment assembly.

12. The medical support device according to claim 11, wherein the receptacle attachment assembly comprises a fastener and a washer having a diameter that is greater than that of the receptacle, the lower end of said stem being adapted to receive the fastener to retain the washer against the lower end.

13. The medical support device according to claim 1, wherein the angle is substantially normal to the longitudinal axis.

14. In combination, an infant bed comprising a receptacle and a medical support device according to claim 1 having the lower end of the stem secured in the receptacle.

15. A method for supporting an infant gastroschisis silo, said method comprising:
providing a medical support device according to claim 1 installed on an infant bed, wherein the lower end of the stem is secured in a bed receptacle whereby the distal end of said elongate member is positioned substantially above an infant subject; and
connecting a tether between a gastroschisis silo on the infant subject and one of the plurality of medical equipment support elements to support the silo.
